(19) United States
(12) Patent Application Publication
(10) Pub. No.: US 2016/0201310 A1
(43) Pub. Date: Jul. 14, 2016

(54) Personal Hygiene Assembly

(71) Applicant: Mian Shaaf Azam, Milton (CA)

(72) Inventor: Mian Shaaf Azam, Milton (CA)

(21) Appl. No.: 14/592,887

(22) Filed: Jan. 8, 2015

(51) Int. Cl. E03D 1/00; E03C 1/02; B05B 1/18

(52) U.S. Cl. CPC E03D 1/003; B05B 1/185; E03C 1/025

(57) ABSTRACT

A personal hygiene assembly includes a toilet. The toilet includes a seat that may be positioned on a support surface. The seat supports a user. A tank is provided. The tank has an perimeter wall coupled to and extending upwardly from a bottom wall of the tank. The tank may contain a fluid. The tank is coupled to the seat. A hose is coupled to the perimeter wall of the tank. The hose is in fluid communication with an interior of the tank. A sprayer is coupled to the hose. The sprayer sprays the fluid. The sprayer may be used to bathe the user.

### BACKGROUND OF THE DISCLOSURE

1. Field of the Disclosure

The disclosure relates to personal hygiene devices and more particularly pertains to a new personal hygiene device for utilizing a toilet for bathing purposes.

2. Summary of the Disclosure

An embodiment of the disclosure meets the needs presented above by generally comprising a toilet. The toilet includes a seat that may be positioned on a support surface. The seat supports a user. A tank is provided. The tank has an perimeter wall coupled to and extending upwardly from a bottom wall of the tank. The tank may contain a fluid. The tank is coupled to the seat. A hose is coupled to the perimeter wall of the tank. The hose is in fluid communication with an interior of the tank. A sprayer is coupled to the hose. The sprayer sprays the fluid. The sprayer may be used to bathe the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a personal hygiene assembly according to an embodiment of the disclosure.

FIG. 2 is a back view of an embodiment of the disclosure.

FIG. 3 is a back perspective view of an embodiment of the disclosure.

FIG. 4 is a top view of an embodiment of the disclosure.

FIG. 5 is a right side view of an embodiment of the disclosure.

FIG. 6 is a schematic view of a method of utilizing an embodiment of the disclosure.

### DESCRIPTION OF THE PREFERRED EMBODIMENT

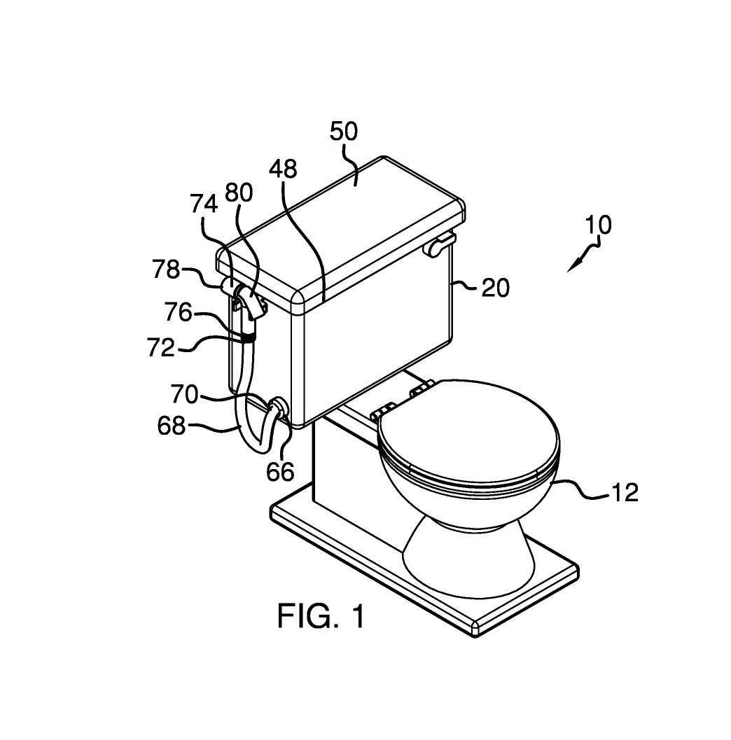

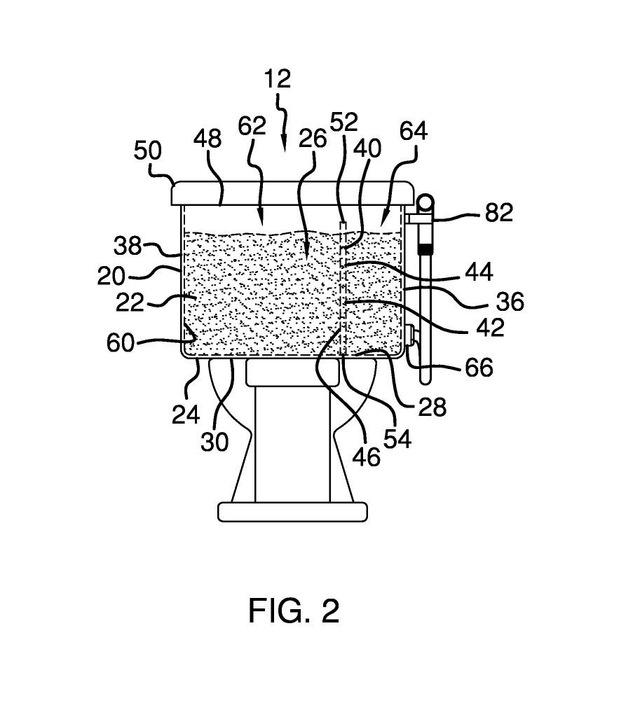

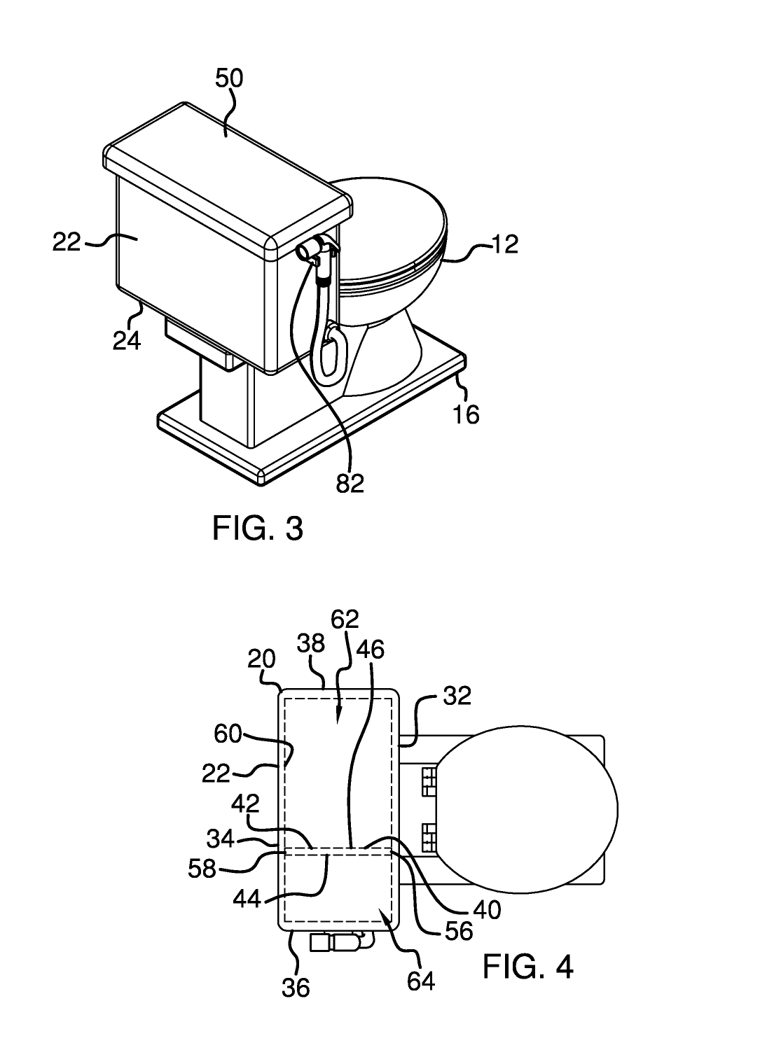

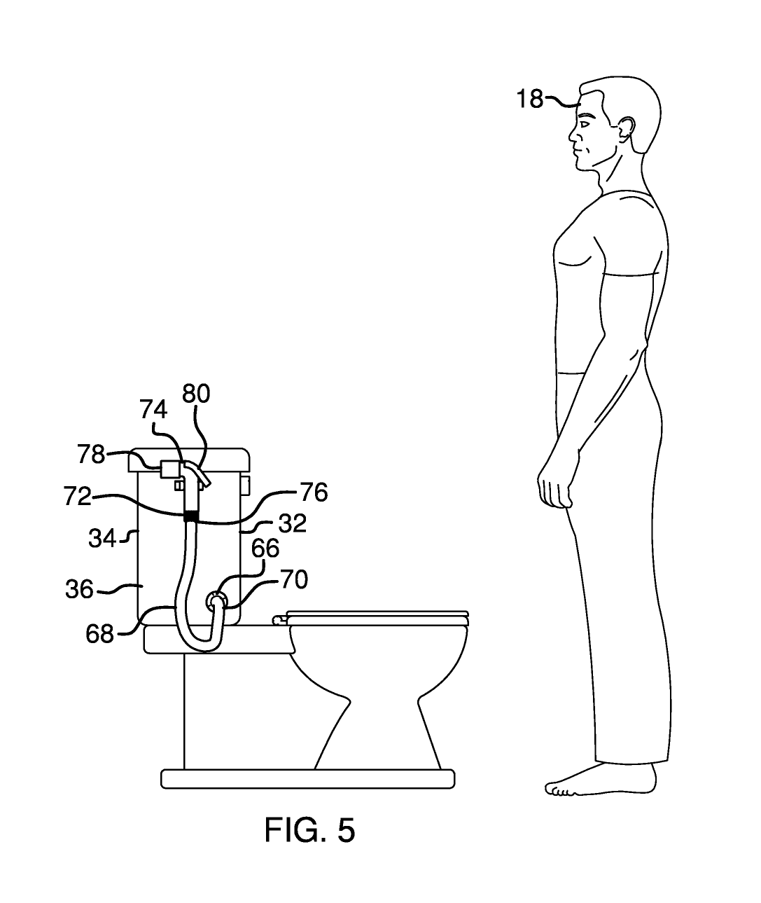

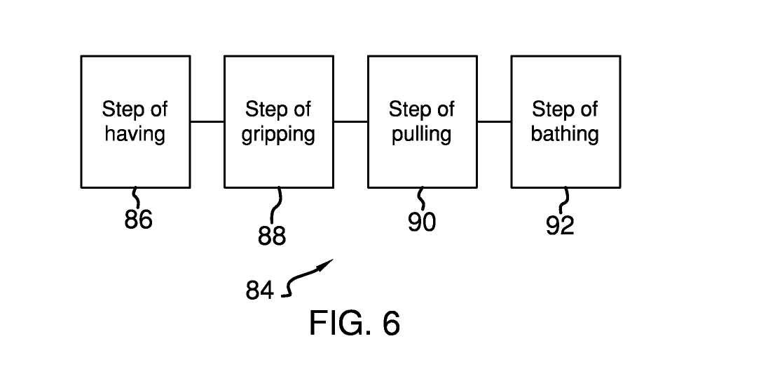

With reference now to the drawings, and in particular to FIGS. 1 through 6 thereof, a new personal hygiene device embodying the principles and concepts of an embodiment of the disclosure and generally designated by the reference numeral 10 will be described.

As best illustrated in FIGS. 1 through 6, the personal hygiene assembly 10 generally comprises a toilet bowl 12. A tank 20 is provided. The tank 20 has a perimeter wall 22 coupled to and extending upwardly from a bottom wall 24 of the tank 20. The tank 20 may contain a fluid 26. Additionally, the tank 20 is coupled to the toilet bowl 12. The fluid 26 may be water.

The bottom wall 24 of the tank 20 has a top surface 28 and a bottom surface 30. The perimeter wall 22 of the tank 20 has a front side 32 and a back side 34 each extending between a first edgeways side 36 and a second edgeways side 38 the of the perimeter wall 22 of the tank 20. A dividing wall 40 is provided. The dividing wall 40 has an exterior edge 42 extending between each of a first lateral surface 44 and a second lateral surface 46 of the dividing wall 40. A top 48 of the tank 20 is open. A lid 50 is positionable on the top 48 of the tank 20 to close the top 48 of the tank 20.

The exterior edge 42 of the dividing wall 40 has a top side 52, a lower side 54, a first oblique side 56 and a second oblique side 58. The lower side 54 of the exterior edge 42 of the dividing wall 40 is coupled to the top surface 28 of the bottom wall 24. Each of the first 56 and second 58 oblique sides of the exterior edge 42 of the dividing wall 40 is coupled to an inner surface 60 of an associated one of the front 32 and back 34 sides of the perimeter wall 22 of the tank 20. The dividing wall 40 is positioned closer to the first edgeways side 36 of the perimeter wall 22 of the tank 20 than the second edgeways side 38 of the perimeter wall 22 of the tank 20. Moreover, the dividing wall 40 defines a flushing reservoir 62 and a washing reservoir 64 within an interior of the tank 20.

A grommet 66 is coupled to the first edgeways side 36 of the perimeter wall 22 of the tank 20. The grommet 66 extends through the first edgeways side 36 of the perimeter wall 22 of the tank 20. Additionally, the grommet 66 is positioned proximate the bottom wall 24 of the tank 20. A hose 68 is provided. The hose 68 has a first end 70 and a second end 72. The first end 70 of the hose 68 is coupled to the grommet 66. The hose 68 is in fluid communication with the washing reservoir 64 in the tank 20.

A sprayer 74 is provided. The sprayer 74 has a coupled end 76 fluidly coupled to the second end 72 of the hose 68 and a free end 78 of the sprayer 74 directed forwardly away from the hose 68. Additionally, the sprayer 74 has a trigger 80 movably coupled thereto. The trigger 80 prevents the sprayer 74 from releasing the fluid 26 until the user 18 pulls the trigger 80.

A clip 82 is provided. The clip 82 is coupled to the first edgeways side 36 of the perimeter wall 22 of the tank 20. Moreover, the clip 82 is positioned proximate the top 48 of the tank 20. The sprayer 74 is positionable within the clip 82. The clip 82 retains the sprayer 74 on the tank 20 when the sprayer 74 is not in use.

In use, a method 84 of utilizing the toilet 12 to perform personal hygiene includes the steps of having 86 the tank 20 of the toilet 12 that contains the fluid 26, the hose 68 fluidly coupled to the tank 20, the sprayer 74 fluidly coupled to the hose 68 and the trigger 80 movably coupled to the sprayer 74. The method 84 further includes a step of gripping 88 the sprayer 74. Continuing, the method 84 includes a step of pulling 90 the trigger 80. The method 84 finally includes a step of bathing 92 in the fluid 26.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A personal hygiene assembly comprising:
a toilet bowl;
a tank, said tank having a perimeter wall coupled to and extending upwardly from a bottom wall of said tank such that said tank is configured to contain a fluid, said tank being coupled to said toilet bowl;
a hose coupled to said perimeter wall of said tank such that said hose is in fluid communication with an interior of said tank; and
a sprayer coupled to said hose, said sprayer spraying the fluid such that said sprayer is configured to bathe the user.

2. The personal hygiene assembly according to claim 1, further comprising a dividing wall coupled to said tank, said dividing wall being positioned within an interior of said tank such that said dividing wall defines a flushing reservoir and a washing reservoir within said tank.

3. The personal hygiene assembly according to claim 2, further comprising said perimeter wall of said tank having a first edgeways side, said hose having a first end and a second end, said first end of said hose being coupled to said first edgeways side of said perimeter wall of said tank such that said hose is in fluid communication with said washing reservoir in said tank.

4. The personal hygiene assembly according to claim 3, further comprising said sprayer having a coupled end fluidly coupled to said second end of said hose and a free end of said sprayer directed forwardly away from said hose.

5. The assembly according to claim 4, further comprising said sprayer having a trigger movably coupled thereto, said trigger being urged by the user such that the fluid in said washing reservoir in said tank is sprayed outwardly from said free end of said sprayer.

6. A personal hygiene assembly configured to be coupled to a toilet, said assembly comprising:
a toilet bowl;
a tank, said tank having a perimeter wall coupled to and extending upwardly from a bottom wall of said tank such that said tank is configured to contain a fluid, said perimeter wall of said tank having a first edgeways side, said tank being coupled to said toilet bowl;
a dividing wall coupled to said tank, said dividing wall being positioned within an interior of said tank such that said dividing wall defines a flushing reservoir and a washing reservoir within said tank;
a hose having a first end and a second end, said first end of said hose being coupled to said first edgeways side of said perimeter wall of said tank such that said hose is in fluid communication with said washing reservoir in said tank;
a sprayer, said sprayer having a coupled end fluidly coupled to said second end of said hose and a free end of said sprayer directed forwardly away from said hose. coupled to said hose; and
said sprayer having a trigger movably coupled thereto, said trigger being urged by the user such that the fluid in said washing reservoir in said tank is sprayed outwardly from said free end of said sprayer such that said sprayer is configured to bathe the user.

7. A method of utilizing a toilet to perform personal hygiene, the steps of the method comprising:
having a tank of said toilet containing a fluid, a hose fluidly coupled to said tank, a sprayer fluidly coupled to said hose and a trigger movably coupled to said sprayer;
gripping said sprayer;
pulling said trigger; and
bathing in the fluid.
